(19) United States
(12) Patent Application Publication
(10) Pub. No.: US 2004/0101020 A1
(43) Pub. Date: May 27, 2004

(54) Packaging and passive alignment of light source to single mode fiber using microlens and precision ferrule

(75) Inventor: Sarvotham M. Bhandarkar, Plano, TX (US)

Correspondence Address: DUKE W. YEE, CARSTENS, YEE & CAHOON, L.L.P., P.O. BOX 802334, DALLAS, TX, 75380, US

(73) Assignee: Photodigm, Inc., Richardson, TX

(21) Appl. No.: 10/304,484

(22) Filed: Nov. 26, 2002

(51) Int. Cl. H01S 3/00

(52) U.S. Cl. 372/109

(57) ABSTRACT

A planar wafer-level packaging method is provided for a laser and a monitor photo detector. The laser and photo detector are affixed to a planar substrate. A lens cap with a microlens is formed and affixed to the substrate with a seal. The lens cap forms a hermetically sealed cavity enclosing the laser and photo detector. Light from the laser is directed and shaped by the lens cap to couple into an external light guide. In an alternate method, the laser may be packaged using flip-chip assembly. A precision protrusion is also provided in the receptacle that fits into a photo-lithographically defined cavity in the substrate of the planar subpackage, thereby passively effecting and maintaining alignment of the axis of the microlens with respect to the central axis of the mating ferrule. The axial distance, in the direction of the laser beam, between the lens and the mating connector ferrule is controlled by the connector stop or front face of the MT ferrule. The axial distance between the lens and the mating connector ferrule may also be controlled by either the depth of the cavity or height of the protrusion. Alternatively, a protrusion that is photo-lithographically defined in the substrate of the subpackage could fit into a cavity in the receptacle or ferrule to passively effect and maintain alignment.

### CROSS REFERENCE TO RELATED APPLICATIONS

The present invention is related to U.S. patent application entitled “Planar and Wafer Level Packaging of Semiconductor Lasers and Photo Detectors for Transmitter Optical Sub-Assemblies,” Ser. No. 10/283,730, attorney docket no. BPHOTO.007, filed Oct. 30, 2002, assigned to the same assignee, and incorporated herein by reference.

### BACKGROUND OF THE INVENTION

1. Technical Field

The present invention relates to lasers and, in particular, to packaging for laser assemblies. Still more particularly, the present invention provides a method and apparatus for packaging a laser and a monitor photo detector on a wafer level planar assembly.

2. Description of the Related Art

Fiber optics are used for short distance communications. A laser (Light Amplification by the Stimulated Emission of Radiation) is a device that creates a uniform and coherent light that is very different from an ordinary light bulb. Many lasers deliver light in an almost-perfectly parallel beam (collimated) that is very pure, approaching a single wavelength. Solid state lasers create ultra-high-speed, miniscule pulses traveling in optical fibers. Light traveling in an optical fiber is impervious to external interference, which is a problem with electrical pulses in copper wire.

An optical fiber is a thin glass strand designed for light transmission. A single hair-thin fiber is capable of transmitting trillions of bits per second. There are two primary types of fiber. Multimode fiber is very common for short distances and has a core diameter of from 50 to 100 microns. For intercity cabling and highest speed, singlemode fiber with a core diameter of less than 10 microns is used.

Two examples of solid-state lasers are the edge emitting laser and the vertical cavity surface emitting laser (VCSEL). VCSELs are fabricated in a chip and the laser is emitted from the surface of the chip. A VCSEL has a wavelength of about 850 mm. A VCSEL can only be used with multimode fibers. Therefore, VCSELs are limited in speed and distance. Edge emitting lasers are fabricated in a chip and the laser is emitted from the edge of the chip. An edge emitting laser has a wavelength between 1300 mm and 1550 mm. An edge emitting laser may be used with a singlemode fiber. However, edge emitting lasers present problems in packaging.

FIG. 1 illustrates an example packaging of an edge emitting laser. The top edge of laser 110 has an anti-reflective (AR) coating while the bottom edge has a highly reflective (HR) coating. Light is generated and is emitted from the top edge, as shown in FIG. 1. The light is directed through lens 120. Residual light from the bottom edge of the laser is measured by photo detector 130. Feedback from the photo detector may be used to control the laser.

As seen in FIG. 1, the packaging of the edge emitting laser is a vertical packaging. This is a difficult process to implement because the laser must be aligned with the lens and the photo detector in a vertical orientation. Furthermore, due to the vertical orientation of an edge emitting laser, the process of aligning and packaging the laser cannot be fully automated. The manufacturer of the laser must either complete the assembly of the laser product or sell the laser chip itself. If a customer buys the laser chip without an assembly, the customer must then face the challenges of aligning, packaging, and testing the laser.

Therefore, it would be advantageous to provide a method and apparatus for packaging a laser in a planar orientation and for allowing passive alignment of the light source to a single mode fiber.

### SUMMARY OF THE INVENTION

The present invention provides a planar wafer-level packaging method for a laser and a monitor photo detector. The laser and photo detector are affixed to a planar substrate. The planar substrate provides electrical connections to the components. A lens cap with a microlens is formed. The lens cap is affixed to the substrate with a seal, such as solder. The lens cap forms a hermetically sealed cavity enclosing the laser and photo detector. The inside surface of the lens cap has a reflective coating with a central opening over the emitting aperture of the laser. The central opening has an anti-reflective coating. Light from the laser is directed and shaped by the lens cap to couple into an external light guide. Residual light from the edge of the laser reflects off the inside surface of the lens cap and is incident upon the photo detector. A plurality of such assemblies, each comprising a laser, a photo detector and a lens cap may be assembled on a single planar substrate. Alternatively a plurality of lasers and photo detectors may be assembled on the planar substrate. Next, a single substrate containing a plurality of lens caps may be aligned and affixed onto the planar substrate to complete the assembly. As yet another variation, the laser and the photo detector could each be arrays instead of single devices in the above embodiments.

In an alternate method, the laser may be packaged using flip-chip assembly. A microlens may be formed on a first side of a substrate with conductive lines and pads on a second side. Antireflective coating is applied on both sides of the substrate. The laser is flip-chip attached to the substrate pads using solder bumps on the second side of the substrate. Light from the laser is directed and shaped by the microlens to couple into an external light guide. The photo detector is affixed to the substrate on the second side. A cap is formed and affixed to the bottom surface of the substrate with a seal, such as solder. The inside surface of the cap has a reflective coating. Residual light from the edge of the laser reflects off the inside surface of the cap and is incident on the photo detector. The cap forms a hermetically sealed cavity enclosing the laser and photo detector. A heat sink attach material may be applied between the laser and the cap. The flip-chip design may be scaled to include a plurality of lasers and photo detectors, and also to include arrays of lasers and photo detectors.

The present invention also provides a precision protrusion in the receptacle that fits into a photo-lithographically defined cavity in the substrate of the planar subpackage, thereby passively effecting and maintaining alignment of the axis of the microlens with respect to the central axis of the mating ferrule. The axial distance, in the direction of the laser beam, between the lens and the mating connector ferrule is controlled by the connector stop or front face of the MT ferrule. The axial distance between the lens and the mating connector ferrule may also be controlled by either the depth of the cavity or height of the protrusion. Alternatively, a protrusion that is photo-lithographically defined in the substrate of the subpackage could fit into a cavity in the receptacle or ferrule to passively effect and maintain alignment.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 illustrates an example packaging of an edge emitting laser;

FIGS. 2A and 2B are diagrams depicting a grating-outcoupled surface emitting laser in accordance with a preferred embodiment of the present invention;

FIGS. 3A-3I are diagrams illustrating packaging of a grating-outcoupled surface emitting laser in accordance with a preferred embodiment of the present invention;

FIGS. 4A-4D are diagrams illustrating flip-chip packaging of a grating-outcoupled surface emitting laser in accordance with a preferred embodiment of the present invention;

FIGS. 5A-5B are diagrams illustrating packaging of an edge emitting laser in accordance with a preferred embodiment of the present invention;

FIGS. 6A-6D are diagrams illustrating flip-chip packaging of an edge emitting laser in accordance with a preferred embodiment of the present invention;

FIG. 7 is a flowchart illustrating a process for packaging a grating-outcoupled surface emitting laser in accordance with a preferred embodiment of the present invention;

FIG. 8 is a flowchart illustrating a process for packaging a surface emitting laser using a flip-chip technique in accordance with a preferred embodiment of the present invention;

FIGS. 9A-9D are example laser assemblies incorporating the surface emitting laser packaging of the present invention;

FIG. 10 is a block diagram illustrating a subassembly combined into a precision molded TOSA assembly with passive alignment in accordance with a preferred embodiment of the present invention;

FIGS. 11A and 11B are block diagrams illustrating a subassembly combined into a precision molded MT/MPO array assembly with passive alignment in accordance with a preferred embodiment of the present invention; and

FIG. 12 is a block diagram depicting a subassembly combined into a precision molded ferrule in accordance with a preferred embodiment of the present invention.

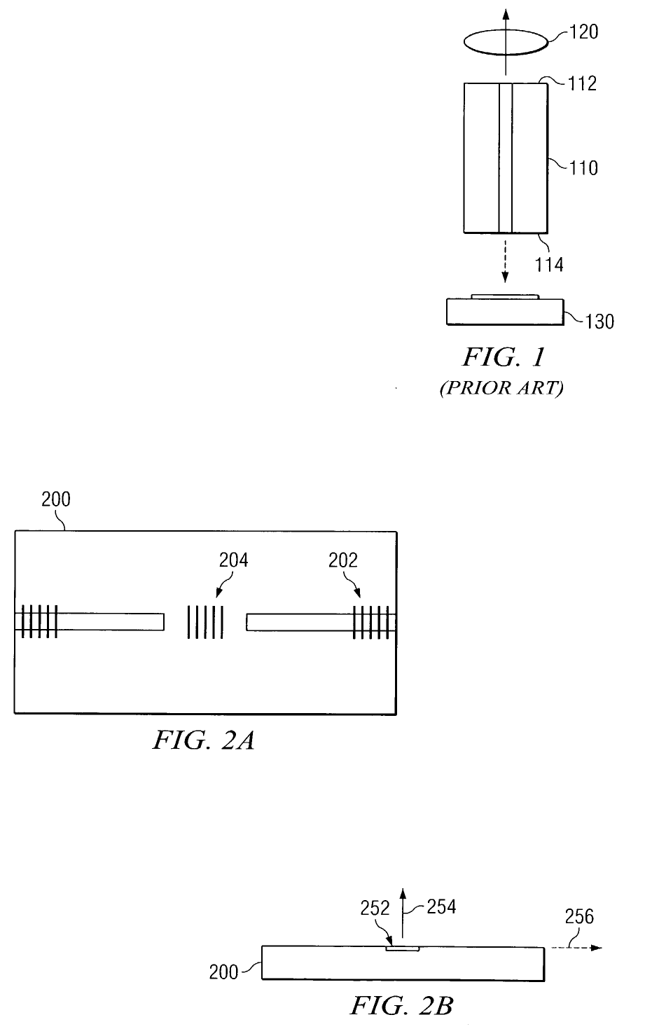

### DETAILED DESCRIPTION

The description of the preferred embodiment of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention the practical application to enable others of ordinary skill in the art to understand the invention for various embodiments with various modifications as are suited to the particular use contemplated.

With reference now to the figures and in particular with reference to FIGS. 2A and 2B, diagrams depicting a grating-outcoupled surface emitting (GSE) laser are shown in accordance with a preferred embodiment of the present invention. Further details for the GSE laser may be found in copending patent application Ser. No. 09/844,484 (Attorney Docket No. PDGM-4) to Evans et al., entitled “Grating Outcoupled Surface Emitting Lasers,” filed on Apr. 27, 2001, and herein incorporated by reference.

FIG. 2A illustrates a top view of a GSE laser, which is an example of a surface emitting laser to be used in a preferred embodiment of the present invention. Laser 200 includes an outcoupling grating 204, which is located at an outcoupling aperture. On either end of the laser are located distributed Bragg reflectors (DBR) 202 for providing feedback into the cavity. Alternatively, cleaved facets may also be used instead of reflector gratings, possibly with highly reflective coatings applied to reflect the light. With either DBR reflectors or coated facets, the reflectivity of one or both ends can be varied to allow light to escape the cavity at that end.

FIG. 2B illustrates a side view of the GSE laser shown in FIG. 2A. Laser 200 includes aperture 252 through which light is emitted. In a preferred embodiment, the outcoupled light 254 is emitted normal to the surface, since one primary goal is to couple this light into a light guide such as an optical fiber. The DBR reflectors or coated facts also allow residual light 256 to escape from the edge. Residual light 256 may be measured by a photo detector to provide feedback for controlling the laser.

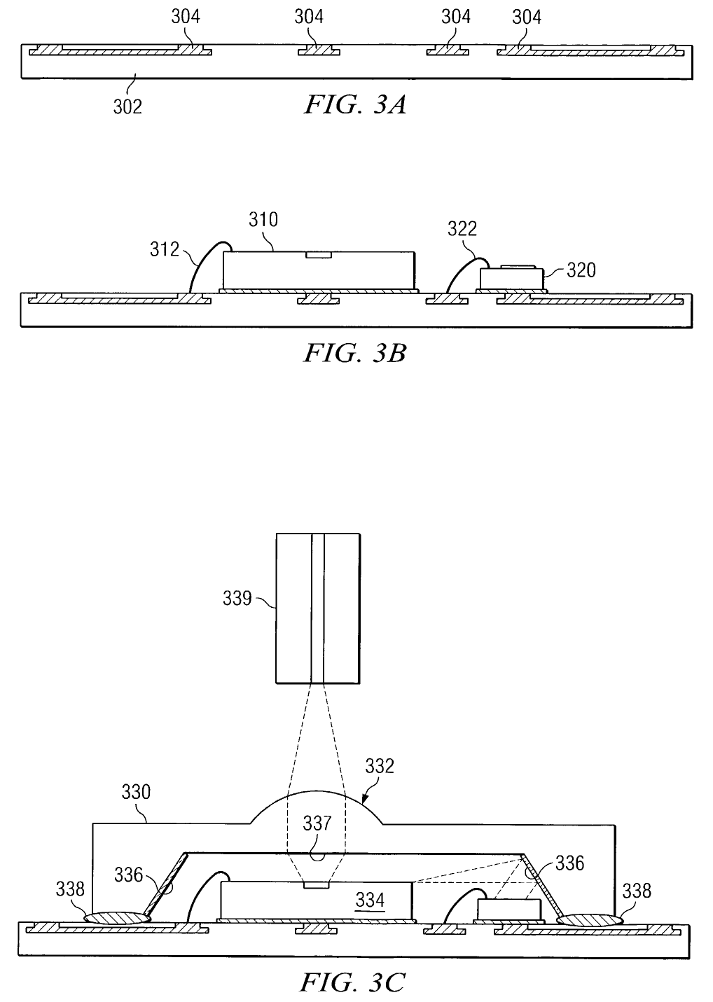

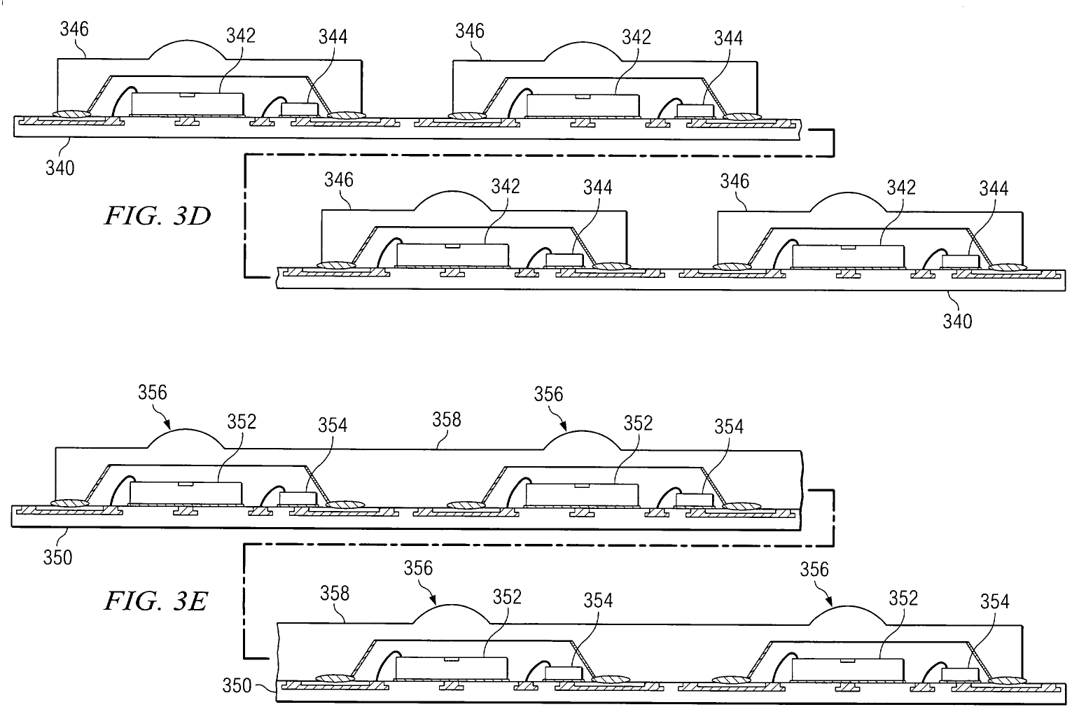

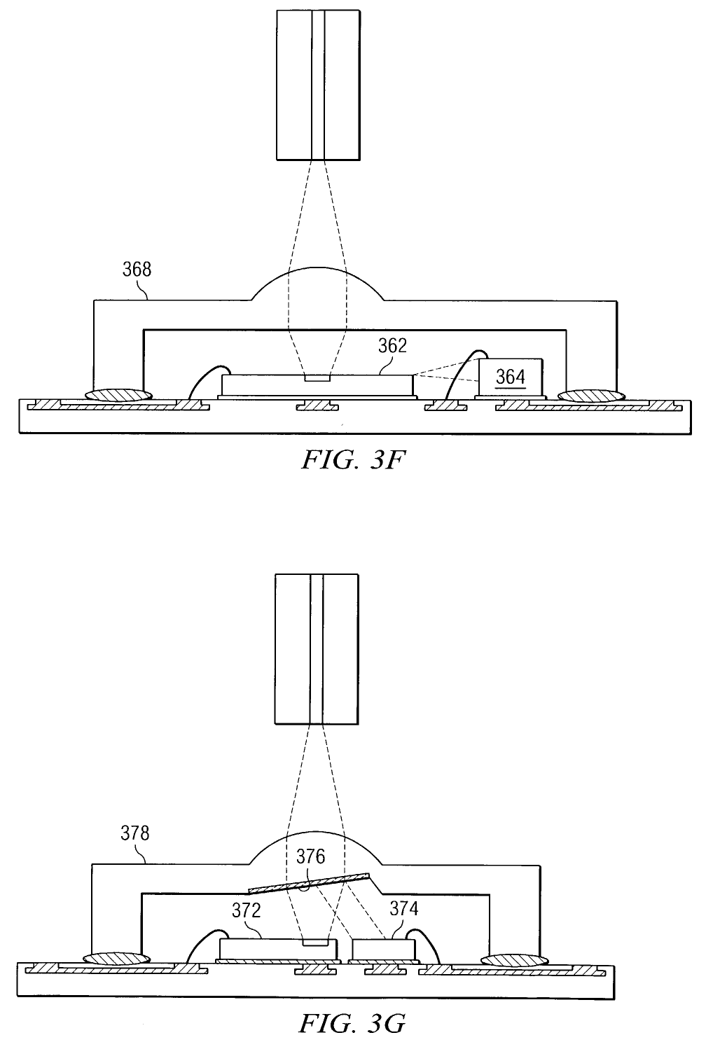

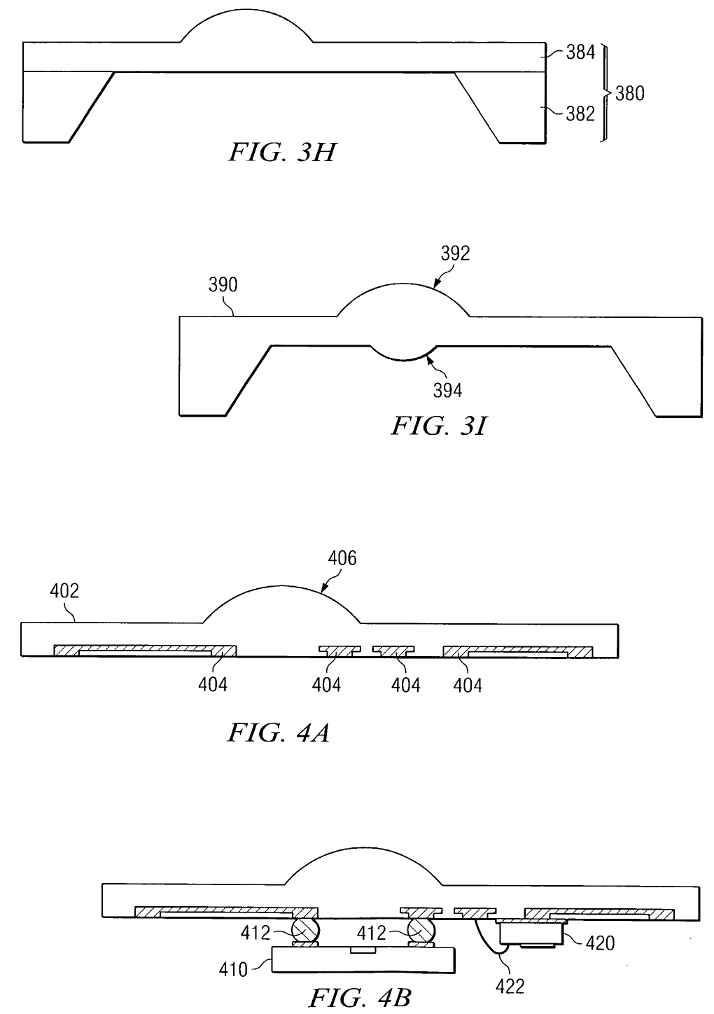

With reference now to FIGS. 3A-3I, diagrams illustrating planar packaging of a surface emitting laser are shown in accordance with a preferred embodiment of the present invention. As shown in FIG. 3A, substrate 302 is formed with conductive lines and pads 304. The conductive lines and pads provide conductive channels from inside the packaging assembly to outside the packaging assembly beneath the surface of the substrate. Substrate 302 may be a semiconductor material, such as silicon.

Next, as shown in FIG. 3B, laser 310 is attached to the substrate at a pad location.

Conductive wire 312 couples laser 310 to a second pad. Monitor photodiode 320 is attached to the substrate at a third pad location. Conductive wire 322 couples photodiode 320 to a fourth pad. In an alternative embodiment of the present invention, a photo detector, such as photodiode 320, may be integrated into laser 310. However, for illustration in FIGS. 3A-3I, the photodiode is shown as a separate element.

Turning next to FIG. 3C, lens cap 330 is formed with lens 332 and recess 334. Lens cap 330 is formed using known molding or semiconductor processing techniques. Whereas a variety of substrates and processing techniques may be used, in a preferred embodiment the lens cap may be formed on a silicon substrate using known grayscale masking techniques to form the lens, combined with bulk anisotropic etching of silicon to form the recess. The inside surface of the lens cap is coated with a reflective coating 336. Reflective coating 336 has a central opening over the laser aperture. The central opening may have an anti-reflective coating 337. Lens cap 330 is attached to the substrate with a seal 338, such as solder. Recess 334 forms a hermetically sealed cavity that completely encloses the laser and photo detector. The conductive lines 304 now provide electrical connections from a portion of the substrate inside the cavity to a portion of the substrate outside the cavity. Light from the surface of the laser is directed and shaped by the lens cap to couple into an external light guide 339. Residual light from the edge of the laser reflects off the inside inclined walls of the lens cap and is incident on the surface of the photo detector 320.

With reference now to FIGS. 3D-3E, diagrams illustrating a plurality of packages on the substrate are shown. As shown in FIG. 3D, a plurality of packages may be constructed on a single substrate 340 each comprising a laser 342, a photo detector 344 and a lens cap 346. FIG. 3E shows another variation in which a plurality of lasers 352 and photo detectors 354 are assembled on a first substrate 350. Next a second substrate 358 comprising a plurality of lens caps 356 may be affixed onto the first substrate to complete the assembly. As yet another variation, the laser and the photo detector could each be arrays instead of single devices, with the array running into the plane of the paper in FIGS. 3A-E.

The planar packaging depicted in FIGS. 3A-3E therefore provides a self-contained package for a surface emitting laser that: a) directs and shapes the light from the laser for the purpose of coupling into an external light guide; b) couples light from the laser into the monitor photo detector; c) provides electrical connections to the laser and photo detector; d) provides protection for the laser and photo detector from the environment. In other words, the planar wafer level package performs all the critical functions of a conventional package.

With reference now to FIGS. 3F-3G, diagrams illustrating alternate methods of coupling light from the edge of the laser into the photo detector are depicted. As shown in FIG. 3F, residual light from the edge of laser 362 is directly coupled into photo detector 364 without the need to reflect off of lens cap 368. In another embodiment, FIG. 3G, a portion 376 of lens cap 378 may be coated with a partial reflective coating. A fraction of the light emitted from the surface of laser 372 reflects off of surface 376 and is incident onto photo detector 374.

Next as shown in FIGS. 3H-3I, the lens cap may be formed in many ways, two preferred embodiments being shown. FIG. 3H shows the lens cap 380 to be formed from two separate elements, a upper half 384 and a lower half 382 being bonded together. FIG. 3I shows an embodiment of a lens cap 390 with multiple lens elements 392 and 394.

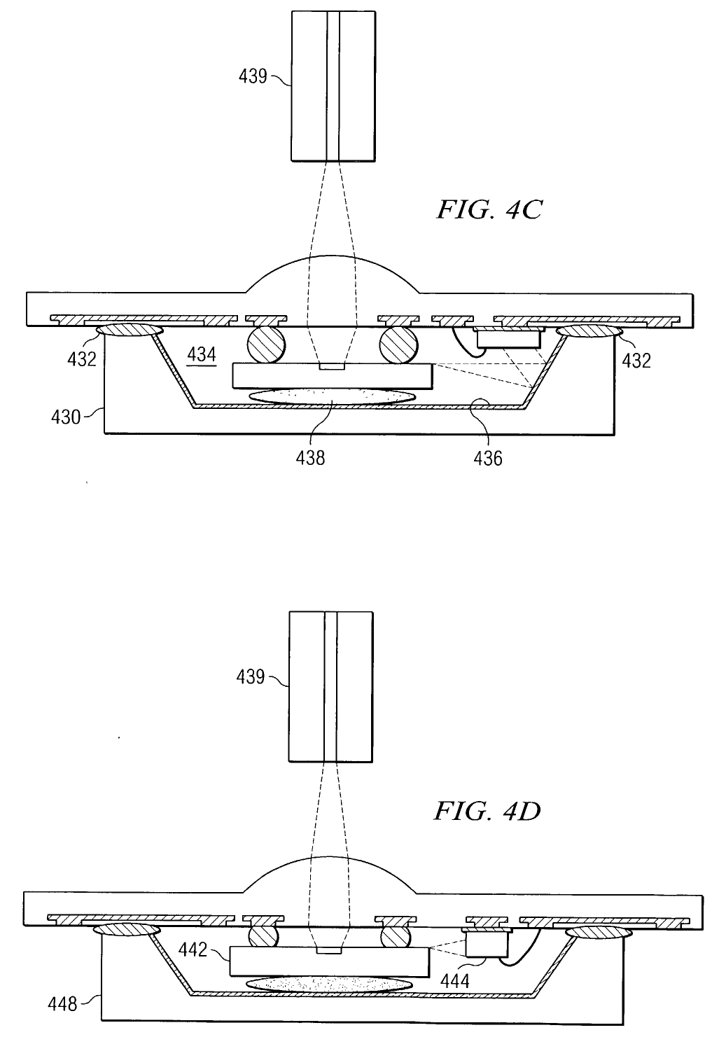

With reference now to FIGS. 4A-4C, diagrams illustrating flip-chip packaging of a surface emitting laser are shown in accordance with a preferred embodiment of the present invention. As shown in FIG. 4A, substrate 402 is formed with conductive lines and pads 404 on a bottom surface and etched with lens 406 on a top surface. The conductive lines and pads provide conductive channels from inside the packaging assembly to outside the packaging assembly beneath the surface of the substrate. Substrate 402 may be, but is not limited to, a semiconductor material, such as silicon. Conductive lines and pads 404 and lens 406 may be formed by using known semiconductor processing techniques. The lens may be formed using known molding techniques or semiconductor processing techniques. More particularly, the lens may be formed using a grayscale masking technique.

Next, as shown in FIG. 4B, laser 410 is attached to the substrate at pad locations by attaching the laser by solder bumps 412. Monitor photodiode 420 is attached to the substrate at a third pad location. Conductive wire 422 couples photodiode 420 to a fourth pad location.

Turning next to FIG. 4C, cap 430 is formed having recess 434. Cap 430 is formed using known molding or semiconductor processing techniques. The inside surface of the cap is coated with reflective surface 436. Cap 430 is attached to the substrate with a seal 432, such as solder. Recess 434 forms a hermetically sealed cavity that completely encloses the laser and the photo detector. Heatsink attach material 438 may be applied between the laser and cap 430. Light from the surface of the laser is directed and shaped by the lens to couple into an external light guide 439. Residual light from the edge of the laser reflects off the inside inclined walls of the cap and is incident on the surface of the photo detector 420.

With reference now to FIG. 4D, a diagram illustrating an alternate method of coupling light from the edge of the laser into the photo detector is depicted wherein residual light from the edge of laser 442 is directly coupled into photo detector 444 without the need to reflect off of cap 448.

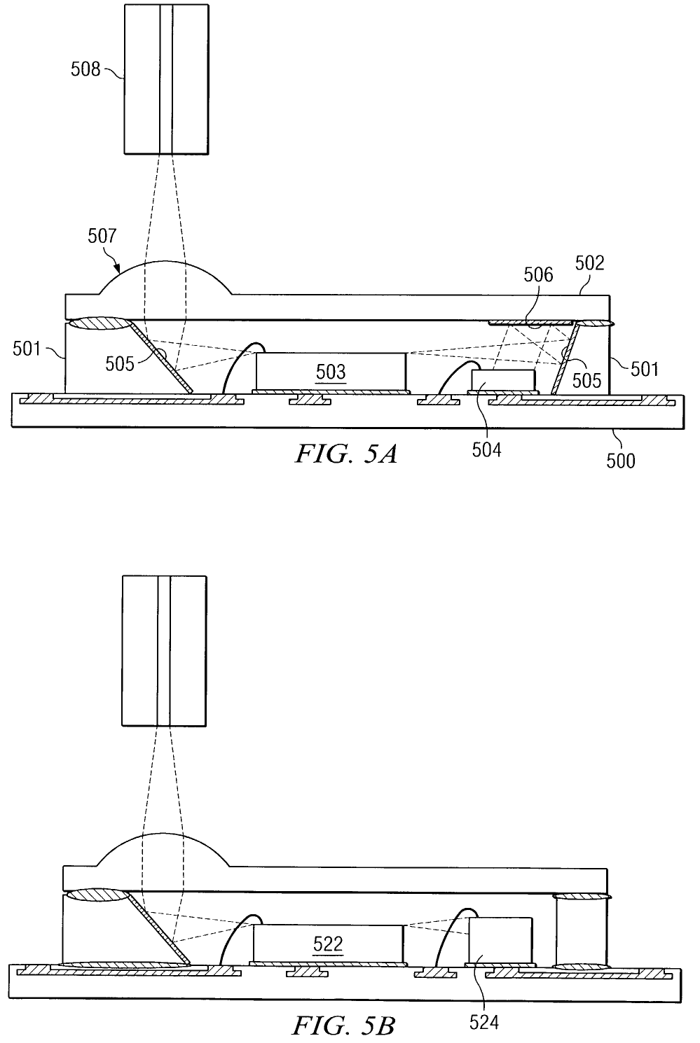

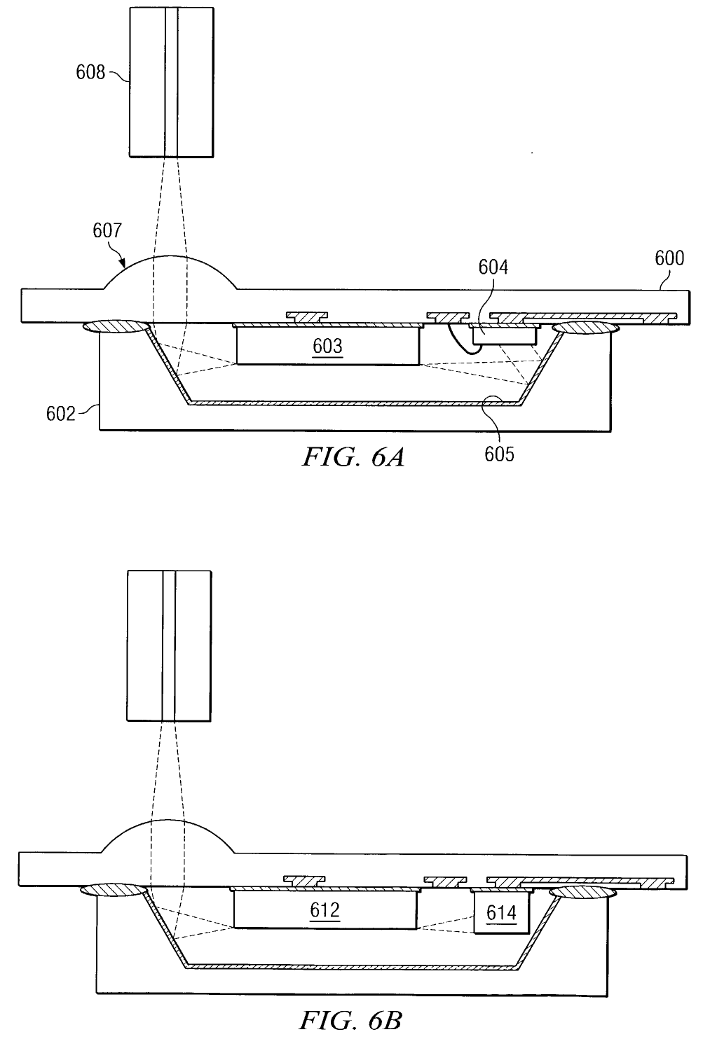

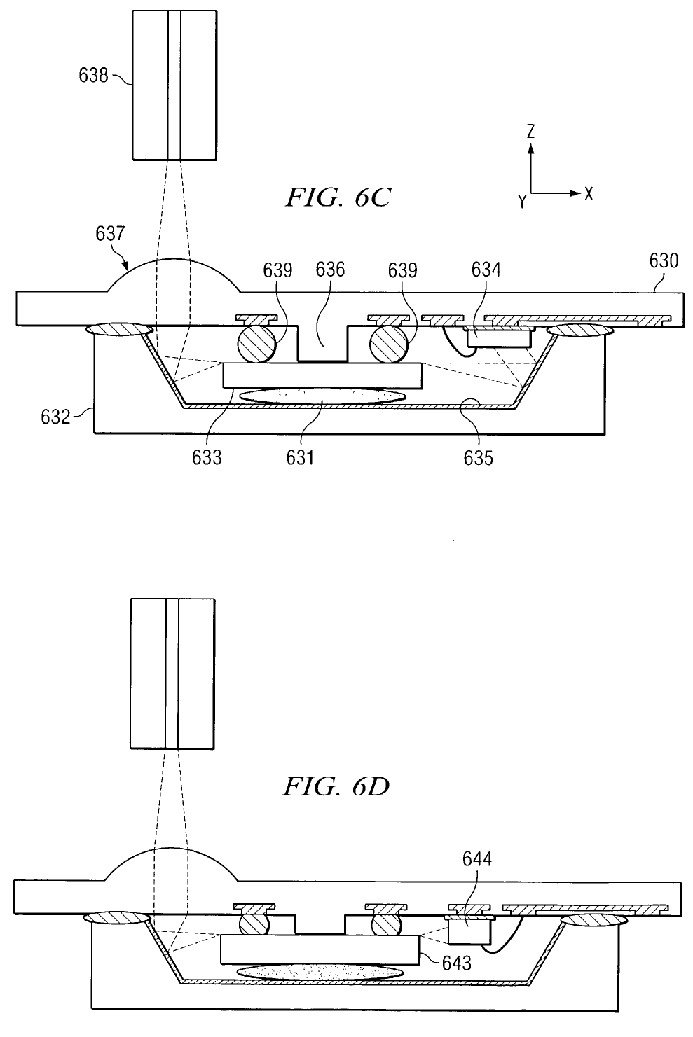

Similar to the planar packaging depicted in FIGS. 3D-3E, the planar packaging shown in FIGS. 4A-4D provides a self-contained package for a surface emitting laser and is easily scalable to include a plurality of individual lasers and photo detectors on a substrate as well as to arrays of lasers and photo detectors.

Whereas the embodiments described thus far are applicable to grating outcoupled surface emitters and conventional surface emitters (VCSELs), the following embodiments described in FIGS. 5A-5B and FIGS. 6A-6D are applicable to edge emitters. As shown in FIG. 5A, substrate 500 is hermetically bonded to interposer 501 which has on its internal walls a reflective coating 505. Edge emitter 503 and photo detector 504 are affixed on substrate 500. Next, lens cap 502 is affixed onto interposer 501. A portion of the bottom surface of lens cap 502 has applied thereon a reflective coating 506. Light from the edge of the laser 503 reflects off one reflective wall 505 and is directed and shaped by lens 507 into light guide 508. Residual light from the other edge of laser 503 reflects off surfaces 505 and 506 and is incident on the photo detector 504. FIG. 5B shows an embodiment similar to that of FIG. 5A, but with the residual light from the edge of the laser 522 being directly coupled into photo detector 524.

With reference now to FIGS. 6A-6D, diagrams illustrating alternate packaging of edge emitting laser are shown. As shown in FIG. 6A, substrate 600 is formed with conductive lines and pads on a bottom surface and etched with lens 607 on a top surface. Next, laser 603 and monitor photodiode 604 are attached to substrate 600. Cap 602 is formed with a reflective coating 605 applied on the inside surface. Cap 602 is affixed to substrate 600 with a hermetic seal. Light from the edge of the laser 603 reflects off of reflective wall 605 and is directed and shaped by lens 607 into light guide 608. Residual light from edge of laser 603 reflects off of reflective coating 605 and is incident on photo detector 604. FIG. 6B shows an embodiment similar to that of FIG. 6A, but with the residual light from the edge of the laser 612 being directly coupled into photo detector 614. FIG. 6C, shows an embodiment similar to FIG. 6A, but with laser 633 affixed to substrate 630 with solder bumps 639. Additionally substrate 630 has a precision standoff 636 that maintains the laser surface at a fixed height from substrate 630. Heatsink attach material 631 may be applied between laser 633 and cap 632. FIG. 6D shows another embodiment similar to that in FIG. 6C, but with photo detector 644 receiving residual light directly from laser 643.

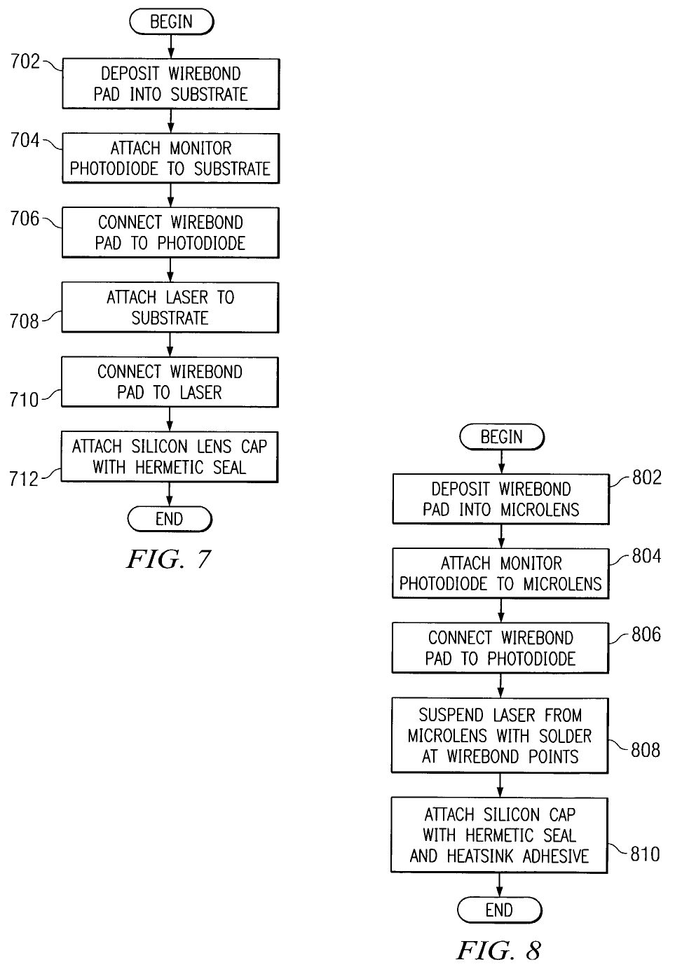

With reference now to FIG. 7, a flowchart illustrating a process for packaging a surface emitting laser is shown in accordance with a preferred embodiment of the present invention. The process begins and conductive lines and pads are deposited into a substrate (step 702). Next, monitor photodiode is attached to the substrate at a pad location (step 704) and the photodiode is electrically coupled to another pad (step 706). Thereafter, the laser is attached to the substrate at a pad location (step 708) and the laser is electrically coupled to another pad (step 710). Then, a silicon lens cap is attached over the laser and the monitor photodiode with a hermetic seal (step 712) and the process ends.

Turning now to FIG. 8, a flowchart illustrating a process for packaging a surface emitting laser using a flip-chip technique is shown in accordance with a preferred embodiment of the present invention. The process begins and conductive lines and pads are deposited into a microlens substrate (step 802). Next, monitor photodiode is attached to the substrate at a pad location (step 804) and the photodiode is electrically coupled to another pad (step 806). Thereafter, the laser is attached to the microlens substrate with solder bumps at two pad locations (step 808). Then, a silicon cap is attached over the laser and the monitor photodiode with a hermetic seal (step 810) and the process ends.

The packaging format described above is advantageous in many ways. One significant advantage is that the planar format lends itself to automated assembly using commercial pick and place equipment available in the semiconductor industry. In particular, the optical axis of the lens can be passively aligned to the optical axis of the laser beam using fiducial marks on the laser and lens cap, with commercial precision pick and place equipment. More particularly, sub-micron alignment precisions, required for improved coupling efficiency into singlemode light guides, can be achieved for example by using eutectic die attach and in-situ reflow on precision die attach equipment. Self-alignment forces of solder reflow may also be used as an alignment mechanism for the flip-chip method. The above methods allow for complete automation and provide much faster assembly times than the tedious active align processes used in conventional packaging.

Furthermore, multiple laser packages may be fabricated on a single substrate wafer further improving assembly throughputs by reducing handling and indexing times. Another key advantage is that the substrate wafer may be bussed on the saw streets to simultaneously energize all packages on the wafer. This enables efficient wafer-level testing and burn-in after which the packages are singulated by dicing the saw streets. The package is hermetically sealed; therefore, it can be incorporated into a laser assembly by the customer without the extra effort of aligning the lens, aligning the photo detector, and hermetically sealing the assembly. The planar package also has a much smaller vertical profile and a smaller footprint than a conventional laser assembly. Another key advantage is that the use of a silicon substrate enables the integration of drive electronics on the substrate which then becomes an enabler for high speed modulation of the laser.

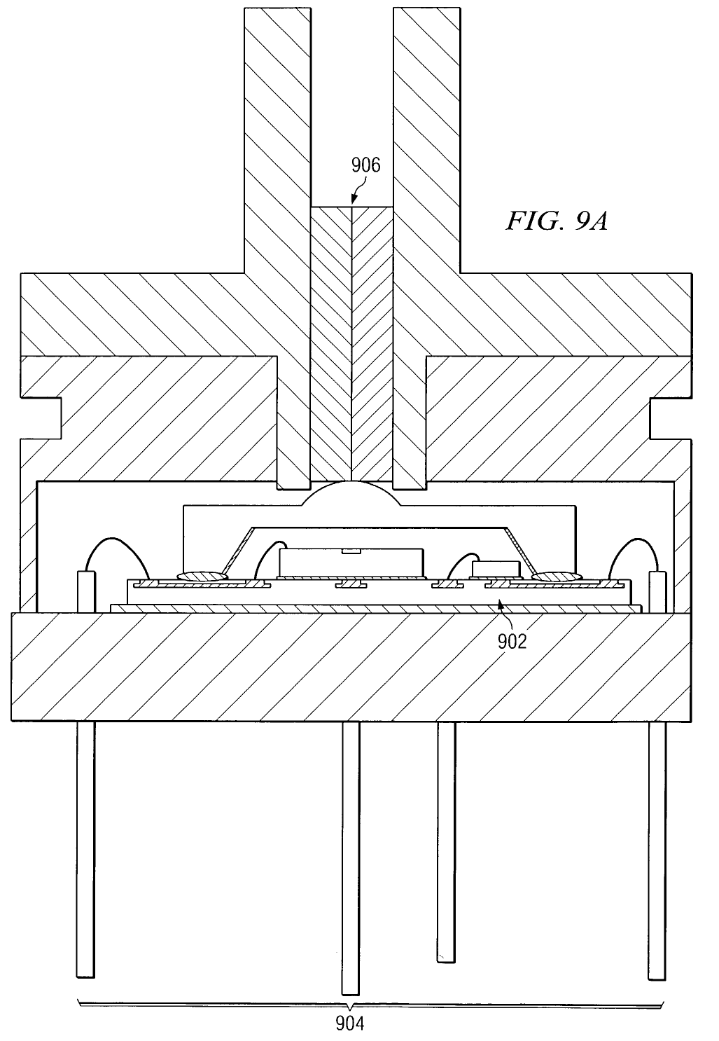

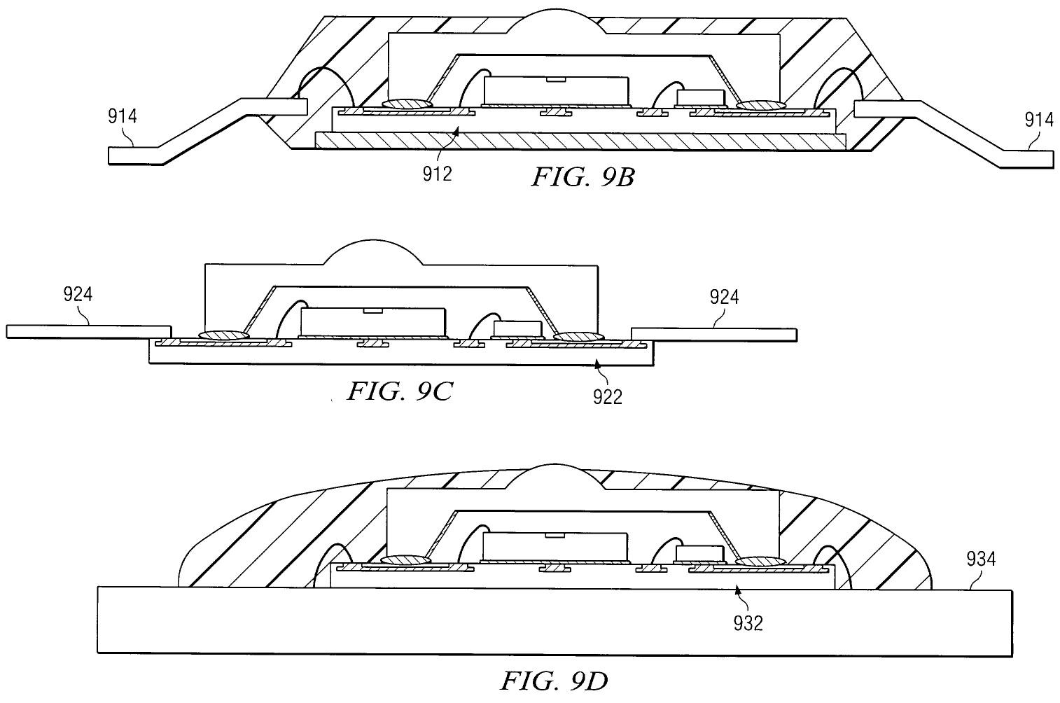

With reference now to FIGS. 9A-9D, example laser assemblies are shown incorporating the surface emitting laser packaging of the present invention. FIG. 9A illustrates a transmitter optical sub assembly (TOSA). Laser package 902 is provided in the TOSA with current being provided by leads 904. The TOSA also has fiber 906 coupled and aligned to the laser.

FIG. 9B illustrates a lead frame package incorporating the planar packaged surface emitting laser of the present invention. The lead frame package incorporates laser package 912 into an assembly that provides external leads 914. FIG. 9C depicts a flex tape assembly. Laser package 922 is coupled to flexible tape 924. Electrical connections are provided through conductive lines within tape 924. FIG. 9D shows a chip-on-board assembly. Laser package 932 may be attached directly to printed circuit board (PCB) 934. Electrical connections may be made from the laser package to the circuit board, making the communications between circuitry on the PCB and the laser package more efficient.

Thus, the present invention solves the disadvantages of the prior art by providing planar packaging for lasers. The alignment and assembly of components in the package is accomplished in a passive manner and therefore may be virtually fully automated using machine vision. Therefore, the packages may be manufactured at a higher volume more reliably and at a lower cost. The use of a silicon substrate enables the integration of drive electronics close to the laser thereby enabling high modulation speeds. The compact planar package has equal or better coupling efficiency. Furthermore, the package is hermetic at the substrate wafer level, thus enabling wafer-level testing and burn-in. Many laser packages may be fabricated on a substrate wafer and testing and burn-in may be performed on all packages on the substrate wafer at one time. Also, a key advantage of this is that subsequent assemblies or packages, such as precision molded TOSA or small outline integrated circuit (SOIC) may be non-hermetic. The planar package of the present invention provides a standard subassembly or subpackage, thus simplifying assembly, testing, burn-in, etc.

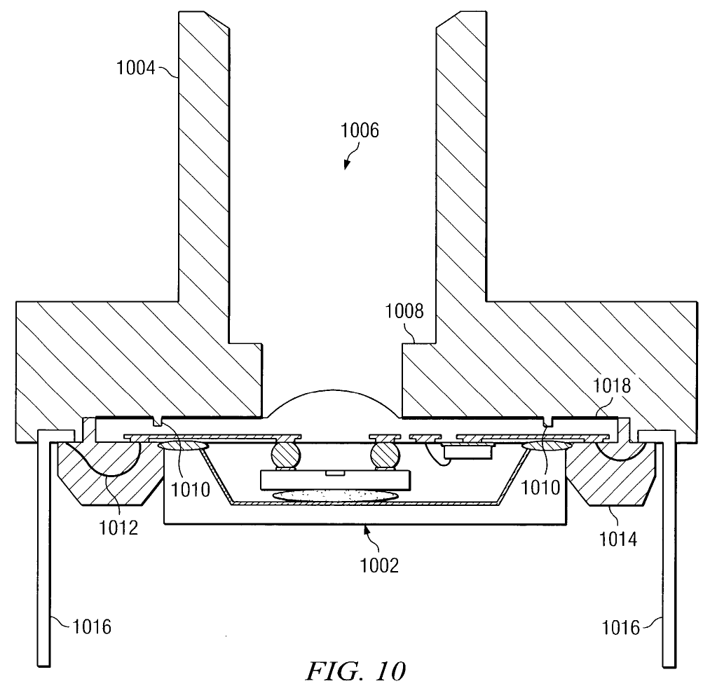

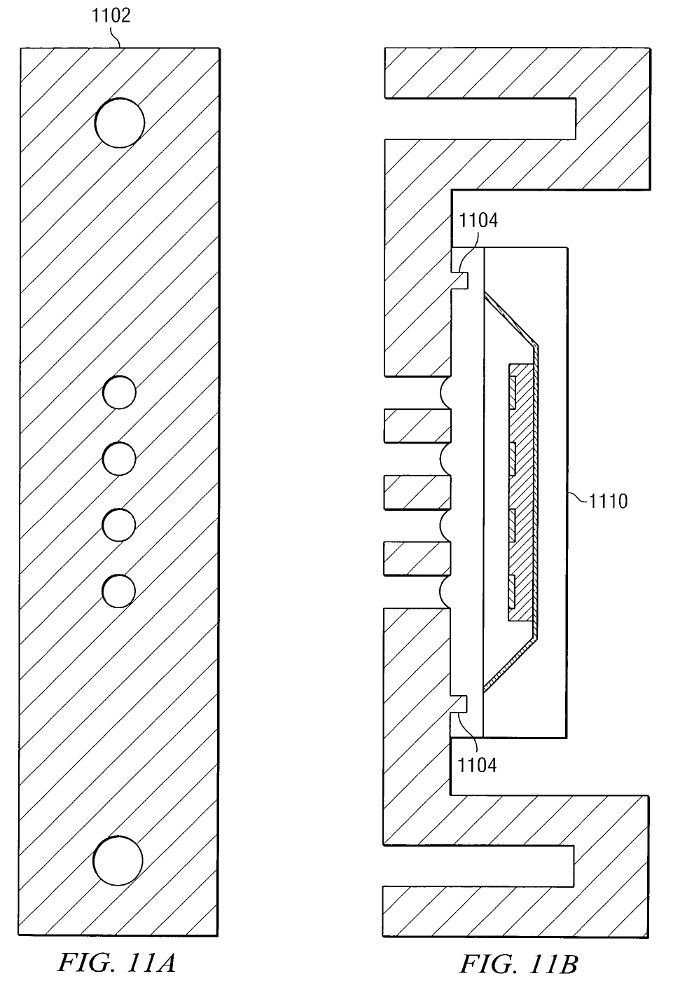

With reference now to FIG. 10, a block diagram is shown illustrating a subassembly combined into a precision molded TOSA assembly with passive alignment in accordance with a preferred embodiment of the present invention. Planar subpackage 1002 is mated with precision receptacle 1004. In the example shown in FIG. 10, the planar subpackage is the flip-chip type, such as that shown in FIGS. 4A-4D. However, the TOSA assembly may also be used with a planar subpackage of the standard type, such as that shown in FIGS. 3A-3G. The precision receptacle is fabricated with a channel 1006 to accept a connection ferrule, which holds a light guide. The precision receptacle also has a ferrule stop 1008 to hold the connection ferrule at a fixed distance from the microlens on subpackage 1002. The precision ferrule is also fabricated such that the connection ferrule, and thus the light guide, is accurately aligned over the microlens.

Receptacle 1004 may also have formed thereon a precision protrusion that fits into photo-lithographically defined cavity 1010 in the substrate of the subpackage. The receptacle may be passively aligned with the planar subpackage by mating the precision protrusion on the receptacle with the cavity in the subpackage. In an alternative embodiment of the present invention, the precision protrusion may be formed on the substrate of the planar subpackage and the cavity may be formed in the precision receptacle. The protrusion-to-cavity mating provides alignment of the optical axis of the laser light beam to the optical axis of the light guide, i.e. two translational and three rotational degrees of freedom are fixed. The mating technique also may serve to maintain the lens at a fixed distance from the ferrule stop, thus fixing the last translational degree of freedom.

Posts 1016 are attached to the combined TOSA assembly to form package leads. The posts may be trimmed and formed after assembly. Conductive leads 1012 electrically couple the planar subpackage to the package leads. The conductive leads are then covered by glob top encapsulant 1014. Thus, the TOSA package may be assembled in a fully automated manner with passive alignment of the light guide.

The laser beam is preferably coupled directly into a single mode fiber of the mating connector ferrule without the need of an intermediate fiber stub. The assembly of the present invention allows drop-in replacement for TO header based packages. The leads of the TOSA may be in the form of a planar leadframe. This would allow planar and matrix processing during assembly. Final configuration may be achieved by a trim and form operation on the leads.

With reference to FIGS. 11A and 11B, block diagrams are shown illustrating a subassembly combined into a precision molded MT/MPO array assembly with passive alignment in accordance with a preferred embodiment of the present invention. As shown in FIG. 11A, MT ferrule body 1102 has a plurality of holes or channels for accepting a light guide. Next, as shown in FIG. 11B, the ferrule body is mated with planar subpackage 1110 by mating precision protrusion 1104 with a photo-lithographically defined cavity in the substrate of the planar subpackage. In the example shown in FIG. 10, the planar subpackage is the flip-chip type, such as that shown in FIGS. 4A-4D. However, the TOSA assembly may also be used with a planar subpackage of the standard type, such as that shown in FIGS. 3A-3G.

The ferrule body may be passively aligned with the planar subpackage by mating the precision protrusion on the receptacle with the cavity in the subpackage. In an alternative embodiment of the present invention, the precision protrusion may be formed on the substrate of the planar subpackage and the cavity may be formed in the precision receptacle. Thus, the MT/MPO array package may be assembled in a fully automated manner with passive alignment of the light guides over lens elements and lasers in the planar subpackage. Coupling may be achieved directly into a single mode fiber of the mating connector ferrule.

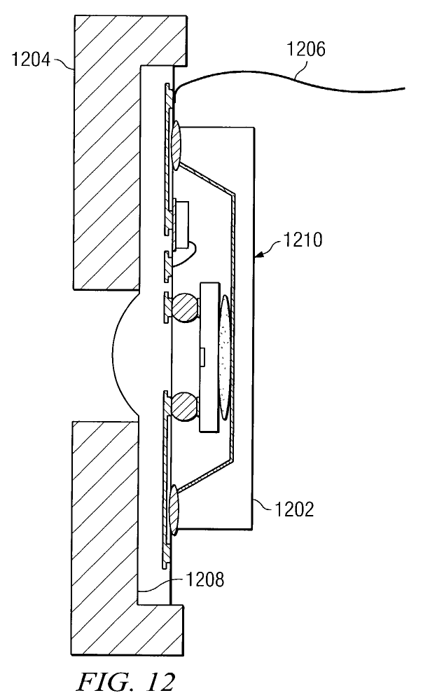

Turning now to FIG. 12, a block diagram is shown depicting a subassembly combined into a precision molded ferrule in accordance with a preferred embodiment of the present invention. Ferrule body 1204 is mated with planar subpackage 1202. Flex tape 1206 may be electrically coupled with conductive pads in the planar subpackage. The ferrule body may be attached to the subpackage using adhesive 1208. A heatsink may be bonded to the back of cap 1210.

While the examples shown in FIGS. 10-12 illustrate TOSA and MT/MPO assemblies, the present invention may also be used with other ferrules and connectors. Furthermore, other modifications to the subpackage may be made within the scope of the present invention. For example, the subpackage may include a VCSEL or an edge emitting laser.

Thus, the present invention provides a precision protrusion in the receptacle that fits into a photo-lithographically defined cavity in the substrate of the planar subpackage, thereby passively effecting and maintaining alignment of the axis of the microlens with respect to the central axis of the mating ferrule. The axial distance, in the direction of the laser beam, between the lens and the mating connector ferrule is controlled by the connector stop or front face of the MT ferrule. The axial distance between the lens and the mating connector ferrule may also be controlled by either the depth of the cavity or height of the protrusion. Alternatively, a protrusion that is photo-lithographically defined in the substrate of the subpackage could fit into a cavity in the receptacle or ferrule to passively effect and maintain alignment.

Thus, the subassembly of the present invention may be simply dropped into a customer-specific package in one final assembly step. Since the planar subpackage is sealed and has a least one aligned lens element and since the planar subpackage may be passively aligned with a customer-specific package, the customer is saved the additional steps of performing tedious alignment, sealing, testing, and burn-in tasks.

What is claimed is:

1. A method of passively aligning a laser assembly comprising:
providing a planar subpackage, wherein the planar subpackage forms a sealed cavity enclosing a laser and wherein the planar subpackage has formed therein a lens element aligned over the laser;
providing a ferrule body, wherein the ferrule body has formed therein a light guide receptacle; and
passively aligning the connection ferrule receptacle with the lens element,
wherein one of the planar subpackage and the ferrule body has formed therein a mating cavity and the other of the planar subpackage and the ferrule body has formed therein a mating protrusion that fits into the mating cavity, and
wherein the step of passively aligning the light guide receptacle with the lens element includes mating the mating protrusion with the mating cavity.

2. The method of claim 1, further comprising:
inserting a connection ferrule into the light guide receptacle, wherein the connection ferrule holds a light guide.

3. The method of claim 2, wherein the step of providing a ferrule body includes providing a ferrule stop in the light guide receptacle, wherein the ferrule stop holds the connection ferrule at a fixed distance from the lens element.

4. The method of claim 2, wherein the light guide is a single mode fiber.

5. The method of claim 1, further comprising:
inserting a light guide into the light guide receptacle.

6. The method of claim 5, wherein the light guide is a single mode fiber.

7. The method of claim 1, wherein the ferrule body is selected from one of a transmitter optical sub assembly and an MT/MPO array assembly.

8. The method of claim 1, further comprising:
attaching conductive leads to the laser assembly; and
electrically coupling the planar subpackage to the conductive leads.

9. The method of claim 1, further comprising:
attaching the subpackage to the ferrule body with an adhesive.

10. The method of claim 1, wherein the laser is a grating-outcoupled surface emitting laser.

11. A laser assembly, comprising:
a planar subpackage, wherein the planar subpackage forms a sealed cavity enclosing a laser and wherein the planar subpackage has formed therein a lens element aligned over the laser; and
a ferrule body, wherein the ferrule body has formed therein a light guide receptacle,
wherein one of the planar subpackage and the ferrule body has formed therein a mating cavity and the other of the planar subpackage and the ferrule body has formed therein a mating protrusion that fits into the mating cavity.

12. The laser assembly of claim 11, further comprising:
a connection ferrule that fits into the light guide receptacle, wherein the connection ferrule holds a light guide.

13. The laser assembly of claim 12, wherein a ferrule stop is formed in the light guide receptacle, wherein the ferrule stop holds the connection ferrule at a fixed distance from the lens element.

14. The laser assembly of claim 12, wherein the light guide is a single mode fiber.

15. The laser assembly of claim 11, further comprising:
a light guide that fits into the light guide receptacle.

16. The laser assembly of claim 15, wherein the light guide is a single mode fiber.

17. The laser assembly of claim 11, wherein the ferrule body is selected from one of a transmitter optical sub assembly and an MT/MPO array assembly.

18. The laser assembly of claim 11, further comprising:
conductive leads attached to the laser assembly, wherein the planar subpackage is electrically coupled to the conductive leads.

19. The laser assembly of claim 11, wherein the subpackage is attached to the ferrule body with an adhesive.

20. The laser assembly of claim 11, wherein the laser is a grating-outcoupled surface emitting laser.
